(19) United States
(12) Patent Application Publication
(10) Pub. No.: US 2004/0187340 A1
(43) Pub. Date: Sep. 30, 2004

(54) Solvent-free microwave extraction of volatile natural substances

(76) Inventors: Farid Chemat, La Reunion (FR); Marie Elisabeth Lucchesi, La Reunion (FR); Jacqueline Smadia, La Reunion (FR)

Correspondence Address: FITZPATRICK CELLA HARPER & SCINTO, 30 ROCKEFELLER PLAZA, NEW YORK, NY, 10112, US

(21) Appl. No.: 10/751,988

(22) Filed: Jan. 7, 2004

(30) Foreign Application Priority Data
Jan. 21, 2003 (EP) 03 001 183.7

(51) Int. Cl. F26B 3/34

(52) U.S. Cl. 34/259

(57) ABSTRACT

The present invention relates to a method for extracting volatile natural substances, for example a plant oil, from biological material, for example from plants, wherein the biological material contains water. The extraction is carried out without the addition of a solvent. Microwave irradiation is used for heating.

The invention is also directed to a method of extracting a volatile natural substance from a biological material, wherein the biological material contains water, as described above, in an atmosphere with reduced pressure.

The present invention also relates to a device for carrying out an extraction method of this type. This device comprises a microwave oven with a microwave chamber for receiving the biological material and a condensation chamber, wherein the condensation chamber is arranged above the microwave chamber, and is connected to the microwave chamber by a connecting channel.

### BACKGROUND OF THE INVENTION

1. Field of the Invention

The present invention relates to a method for extracting volatile natural substances containing water using microwave radiation and is carried out without the addition of a solvent.

2. Related Background Art

In hydrodistillation the material to be extracted, i.e. for example plants, is immersed in water and then the water is brought to boiling by the supply of heat. This requires the supply of comparatively high quantities of energy. Another possibility is steam distillation, in which the steam is guided directly to the material to be extracted.

Methods for extracting natural substances, which are carried out without the addition of solvents, are known. For example, a method is disclosed in EP 0 698 076 B1, in which biological material is heated by means of microwave irradiation. This leads to the evaporation of the water located in the plant cells and then to the breaking open of cell structures, so that in this process, apart from steam, oil located in the plants is also freed.

The pressure in the microwave chamber is in the process temporarily significantly reduced to encourage the process of releasing cell content to the outside. The evaporation of plant water leads in the process to a reduction in the temperature. This is partially compensated by further heating. The proposed device in the meantime has, as a prerequisite, comparatively high expenditure for apparatus as the microwave chamber has to be designed as a pressure chamber.

A further solvent-free extraction method is known from the article “Microwave Oven Extraction of an Essential Oil” by A. A. Craveiro et al. from the Journal “Flavour and Fragrance Journal”, Vol. 4, pages 43 to 44, 1989. Biological material is also heated in this method by microwave irradiation. The vapours occurring here contain plant oil and are removed from the microwave oven and cooled so the oil condenses.

According to this method, air from outside the microwave oven is pumped into the interior of the microwave oven. This causes an airflow with which the released oil can be conveyed away. Because air is supplied by means of an air pump from outside the microwave oven, in principle, there is the risk of introducing undesired substances, which can impair the purity of the extracted oil.

A need still exists for a method of extracting volatile natural substances from biological materials using microwave radiation, without the addition of solvents, and that does not jeopardize the purity of the oil to be extracted or require the special and costly construction of a high pressure microwave chamber.

### SUMMARY OF THE INVENTION

The present invention relates to a method for extracting volatile natural substances, for example a plant oil, from biological material, for example from plants, wherein the biological material contains water. The extraction is carried out without the addition of a solvent. Microwave irradiation is used for heating.

The method comprises introducing the biological material into a microwave chamber with the exclusion of solvent, irradiating the biological material with microwaves until at least some of the natural substance is released from the biological material, conveying the released natural substance from the microwave chamber into a condensation chamber by convection, cooling the released natural substance until it condenses, and conveying the released natural substance from the condensation chamber.

The invention is also directed to a method of extracting a volatile natural substance from a biological material, wherein the biological material contains water, as described above, but further comprises irradiating the biological material with microwaves until at least some of the natural substance is released from the biological material in an atmosphere with reduced pressure.

The present invention also relates to a device for carrying out an extraction method of this type. This device comprises a microwave oven with a microwave chamber for receiving the biological material and a condensation chamber, wherein the condensation chamber is arranged above the microwave chamber, and is connected to the microwave chamber by a connecting channel.

### BRIEF DESCRIPTION OF THE DRAWINGS

FIG. 1 shows an embodiment of the device of the present invention and

FIG. 2 shows another possible embodiment of the device of the present invention.

### DETAILED DESCRIPTION

An advantage of solvent-free extraction methods can generally be seen in that it is not necessary following the extraction process to separate the extracted substance from the solvent to obtain the concentrated extract.

The invention is based on the object of proposing a solvent-free, efficient extraction method, which avoids in particular the above-mentioned drawbacks of the prior art. The method should also be able to meet particularly high purity requirements. A further aim of the invention is to propose a corresponding device, which can be produced comparatively simply.

According to a first aspect of the invention, a method for extracting a volatile natural substance from biological material is proposed. The biological material contains plant and/or added water, which is circulated.

To practice the method of the invention the biological material, for example plants, is introduced into a microwave chamber, i.e. for example a microwave oven. The biological material does not have to be particularly finely crushed here. For example, leaves in whole pieces can be used. Solvent is not added. Then the biological material is irradiated with microwaves. This leads to the heating of the water located in the plants until it evaporates and then to the bursting of the walls of the plant cells containing water. Therefore, together with the evaporation of the water, volatile natural substances located in the biological material are released. The vapours containing, in particular, plant water and the natural substance(s) to be extracted are discharged upwardly out of the microwave chamber using the convection occurring naturally owing to the heating and are passed into a condensation chamber. The vapours are cooled in this condensation chamber until the released natural substance condenses. The natural substance, which has been liquefied in this manner, is then conveyed from the condensation chamber. All the conveying processes take place owing to a natural cycle without mechanical aids (pumps etc.).

The microwave chamber and the condensation chamber are advantageously closely connected to one another and form parts of an outwardly sealed system. In this manner, the introduction of undesired substances into the system can be prevented. Therefore the highest purity requirements can be met in a gentle manner.

The volatile natural substance may be, for example, a plant oil or other distilled oils.

The temperature in the microwave chamber can advantageously be measured during the irradiation of the biological material with microwaves and as a function thereof the microwave irradiation can be regulated in a manner known per se, so a temperature below 100° C. is maintained in the microwave chamber. A temperature range of about 80° C. to 90° C. should preferably be maintained.

If the biological material is stirred during the irradiation (magnetic stirrer etc.) improved exposure and a particular uniform irradiation can be brought about thereby.

A thorough mixing and therefore improved exposure can also be achieved by a rotatable, obliquely arranged receiving container for the biological material. A particularly uniform irradiation can also be achieved thereby.

The condensation chamber located above the microwave chamber is preferably separated from the microwave chamber by a partition, which tapers upwardly and has an aperture in this instance in the upper region, through which the air, owing to convection, can pass. In this manner, the vapours in this region are thermally prevented from receding in the direction of the microwave chamber.

Additional heat can preferably be supplied in a transition region between the microwave chamber and the condensation chamber in order to thus assist the convection movement of the air and prevent condensation in this region.

Cooling in the condensation chamber preferably takes place by wall cooling. A droplet formation of the natural substance can thus be achieved on the wall of the condensation chamber and this then leads to easier separation of the condensed material from the condensation chamber.

The released, condensed natural substance can advantageously be conveyed from the condensation chamber through a channel which in the base region leads out of the condensation chamber so liquid is discharged following gravitational force. A receiving vessel connected to the channel can be used to receive the condensed natural substance.

In order to prevent premature drying out of the irradiated biological material, water condensed in the condensation chamber is advantageously again fed to the microwave chamber. An overflow device connected to the receiving vessel, and with which water is separated from the condensed natural substance before it is fed to the microwave chamber again can be used, for example, for this purpose. The water can be kept circulating in the system in this manner while the natural substance accumulates in the receiving vessel.

According to a further aspect of the invention, a device for extracting a volatile natural substance from biological material is provided, having the following components: a microwave oven with a microwave chamber provided for receiving biological material; the device also has a condensation chamber which is located above the microwave chamber and is connected thereto by a connecting channel. Air from the microwave chamber can arrive in the condensation chamber through this connecting channel.

The microwave chamber and the condensation chamber advantageously form parts of a closed system. The introduction of undesired substances can be prevented in this manner.

The microwave chamber also advantageously has stirring means provided for thorough stirring of the introduced biological material. Thorough stirring of this type improves exposure of the biological material and leads to a particularly uniform temperature distribution during microwave irradiation.

A particularly homogeneous temperature distribution and improvement in the exposure, particularly with comparatively intensively crushed biological material is also offered by an obliquely arranged, rotatable receiving container. The axis of rotation can be arranged along an axis of symmetry of the receiving container. A receiving region for the material in this instance may advantageously be asymmetrical in design to the axis of rotation. A comparable device as such is also known from the German patent application 102 27 836.9

It is particularly expedient if the condensation chamber is separated from the microwave chamber by a partition which has an upwardly tapering form and has an aperture in the upper region, the aperture being dimensioned such that air moved by convection can pass through. The vapour, containing the natural substance and plant water, is prevented by the tapering form from receding in the direction of the microwave chamber. The partition is preferably made of plastics material or glass.

A condensation chamber which has the form of a vertically oriented cylinder is suitable as a particularly simple embodiment. The connecting channel is also advantageously formed in the form of a vertically oriented cylinder.

The connecting channel and the condensation chamber may, for example, be formed in one part or two parts.

The connecting channel may have heating, for example in the form of electrical wall heating which is suitable for assisting the convection movement of the vapour-containing air in this region and preventing condensation in this region.

The condensation chamber also advantageously has cooling means, for example in the form of wall cooling. This is easy to produce, for example as water cooling.

For easy conveyance of the condensed natural substance from the condensation chamber, the condensation chamber in its base region may have an outlet, for example in the form of a channel. This may be connected to a receiving vessel for receiving condensed natural substance.

The outlet or the receiving vessel is also advantageously connected to an overflow device which serves to separate natural substance and water. The overflow device may be designed in such a way that overflowing water can in turn be fed to the microwave chamber.

Further advantages and properties will now be described with the aid of a detailed description of an embodiment and with reference to the figures of the accompanying drawings, in which:

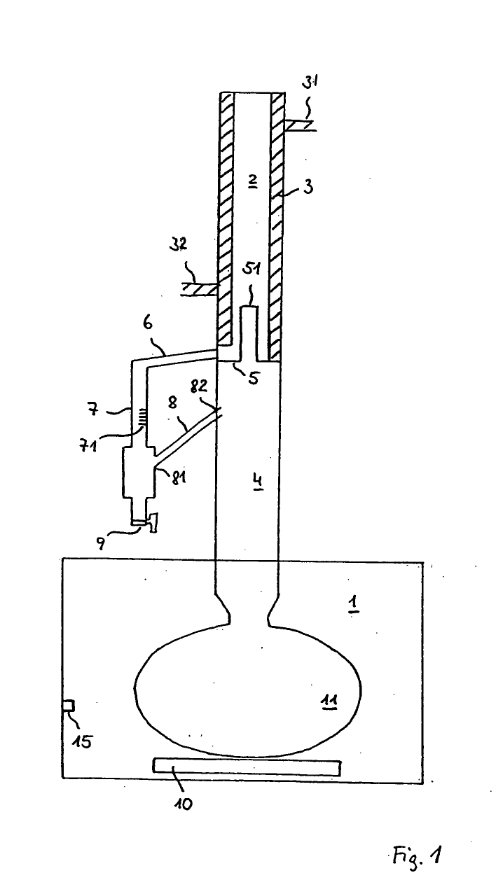

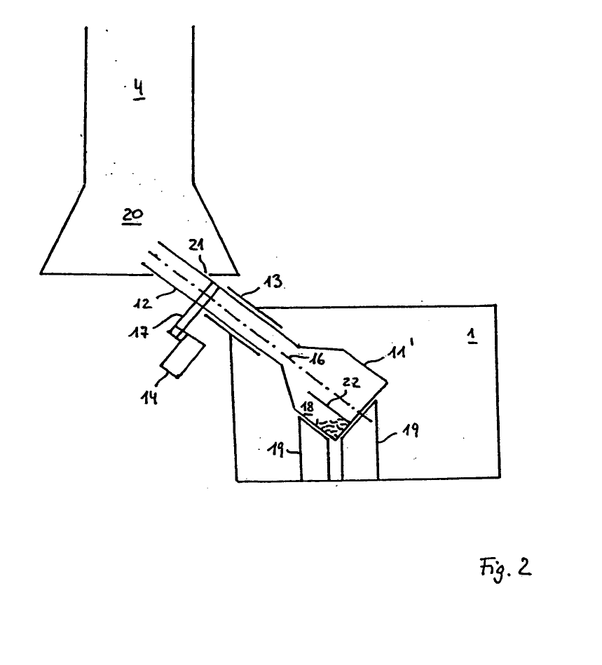

FIG. 1 shows a schematic cross-section through a device according to the invention, and FIG. 2 shows a schematic view of an alternative embodiment possibility of the receiving container in the microwave chamber.

FIG. 1 shows a schematic view of the device according to the invention for extracting volatile natural substances, for example oils, from biological material such as, for example, plant leaves or the like.

FIG. 1 shows a microwave chamber 1. This may be, for example, the closable interior of a microwave oven. A microwave generator (not shown) is also provided through which the interior of the microwave chamber 1 can be irradiated with microwaves. A microwave-transparent receiving container 11 in the interior of the microwave chamber 1 serves to receive the biological material during the treatment (extraction).

The receiving container 11 is rotatably mounted with respect to the microwave chamber 1, for example, by means of a rotary disc 10. A homogeneous temperature distribution in the biological material is provided by rotating the receiving container 11 during irradiation.

Stirring means (not shown) can also be provided which provide thorough stirring of the biological material during the irradiation, to thus improve the exposure of the material and the homogeneity of the irradiation.

The microwave chamber 1 also has a temperature measuring device 15 in the form of an infrared sensor, with which the temperature of the irradiated material can be continuously detected without contact during the irradiation. As a function of the detected temperature, the microwave irradiation is adjusted such that a desired temperature range is adjusted in the irradiated material. This takes place in such a way that once a temperature of, for example, about 80° C. to 90° C. has been reached (heating) the temperature in this desired range of, for example, about 80° C. to 90° C. and therefore below the boiling point of water at normal pressure is maintained. Gentle extraction is thus ensured.

As an alternative, the extraction can be carried out with boiling water, i.e. at normal pressure, and at a temperature of 98° C. to 100° C.

As an alternative, the extraction can be operated in a reduced pressure of, for example, 200 mbar to 500 mbar, preferably about 300 mbar. The boiling point of water reduces accordingly, for example to about 68° C. at an absolute pressure of 300 mbar. The extraction at this reduced temperature proceeds correspondingly more gently for those often heat-sensitive aromatic essences which decompose at a higher temperature.

The receiving container 11 can be provided for this extraction under vacuum with a connection to which a vacuum pump is connected (neither shown in the figure).

The receiving container 11 is connected at the top to a cylindrical connecting channel 4 via a tight seal. The connecting channel 4 projects upwardly from the microwave chamber 1. For this purpose, the microwave chamber 1 has a hole.

The connecting channel 4 is, for example, made of glass, and surrounded by electrical wall heating (not shown) which prevents condensation of the vapours rising in the connecting channel 4 in this region.

In its upper region, the connecting channel 4 is delimited by a partition 5. This partition 5 may be made of glass or plastics material. Its base is arranged horizontally. In the centre of the base is, for example, a circular, centrally arranged base aperture, from which the form of the partition 5 passes into a cylindrical tube leading upwardly. With respect to its vertical sections, the partition 5 according to this embodiment, i.e. in its upward course, has an abrupt diameter reduction.

The tube formed in this way by the partition 5 is open at the top and thus gives rise to the opening 51. The tube therefore forms a vertically upwardly pointing channel-like or nozzle-like structure.

A condensation chamber 2, separated by the partition 5, adjoins above the connecting channel 4. The nozzle-like structure of the partition 5 therefore represents a transition from the connecting channel 4 into the condensation chamber 2 and projects, while overlapping with the cooled wall of the condensation chamber 2, into this condensation chamber 2.

The condensation chamber 2 according to this embodiment also has the form of a vertically oriented cylinder, for example with the same internal diameter as the connecting channel 4 and is designed in such a way that the aperture 51 of the partition 5 lies symmetrically to the centre line of the condensation chamber 2. The lower rim of the condensation chamber 2 is located below the level of the aperture 51 and directly borders the outer edge of the partition 5.

The condensation chamber 2 is equipped with wall cooling 3 which extends uniformly following the course of the wall to below the aperture 51, for example to the lower rim of the condensation chamber 2. This is, for example, water cooling (or other fluid cooling) with a feed line 32 for cool water and a discharge line 31 for heated water.

In the region of its lowest point, the condensation chamber 2 has an outlet channel 6 leading to a receiving vessel 7. The outlet channel 6 is slightly downwardly inclined, the receiving vessel 7 has a cylindrical form and is vertically oriented.

The receiving vessel 7 is connected to an overflow device. This is produced according to the embodiment by a tube 8 which is guided obliquely upwardly from the receiving vessel 7 and opens below the level of the upper rim of the receiving vessel 7 into the connecting channel 4. The receiving vessel 7 has a level scale 71 from the level of the opening 82 of the tube 8 of the overflow device upwards into the connecting channel 4.

At its lowest point, the receiving apparatus 7 has an outlet valve 9.

In the assembled state, the receiving container 11, the connecting channel 4, the condensation chamber 2, the outlet channel 6, the receiving vessel 7 and the overflow tube 8 form a sealed system. The seal is adequately tight here so that an introduction of undesired substances during the method is ruled out.

To carry out the method according to the invention, firstly biological material is fed into the receiving container 11. This is placed on the rotary disc 10 in the microwave chamber 1 and tightly connected to the connecting channel 4. The biological material, for example, plant material contains water in its cells. Prior to the treatment, water is optionally added once, in that, for example the biological material is soaked in water prior to extraction. However, no solvent is added.

The microwave irradiation is then started. The irradiation of the biological material in the receiving container 11, owing to absorption of the microwave irradiation by the water molecules, leads to heating of the plant water and then to an increase in the pressure within the cells containing the water. This leads subsequently to a bursting of the walls of the plant cells in which water is deposited and a discharge of steam which entrains other volatile constituents.

The temperature of the biological material is continuously or periodically measured by the infrared sensor 15. Once a temperature of, for example, 80° C. to 90° C. is reached, the irradiation is controlled as a function of the temperature, measured in such a way that the temperature is maintained in said desired value range.

The heating of the water molecules passing into gaseous form in the course of radiation in the receiving container 11 in the microwave chamber 1 causes an upward convection movement of the vapour-containing air to form automatically above the biological material. This movement causes the vapour mixture (water and other moist substances) therefore to rise without mechanical assistance (pumps etc.) into the connecting channel 4. The marginal electric heating of the connecting channel 4 heats the connecting channel 4 from the outside during this process, so the convection movement is further assisted by the supply of heat in this region and an undesired condensation of the vapour mixture on the walls of the connecting channel 4 is prevented.

The rising vapours finally reach the region of the partition 5 and are forced through it by the channel-like or nozzle-like structure formed by the partition 5, wherein the flow rate accelerates. The vapours receding or an undesired backflow of the condensate downwards is prevented thereby.

The vapours subsequently flow through the aperture 51, so they arrive in the condensation chamber 2. Owing to the expansion of space there, there is then a fanning out of the vapour flow, so the vapours are preferably guided to the walls of the condensation chamber 2, where they cool down and sink.

Owing to the water cooling 3, a cooling of the vapour-containing air in the condensation chamber 2 is brought about and this finally leads to droplet formation, preferably on the interior wall of the condensation chamber 2.

The droplets consist here partially of water and partially of condensed plant oil. Following gravitational force, these droplets on the internal wall of the condensation chamber 2 flow downwards, collect at the base of the condensation chamber 2 and are finally guided through the outlet channel 6 and onwards into the receiving vessel 7.

The outlet valve 9 is initially closed, so the mixture of water and oil collects in the receiving vessel 7. However, the lighter oil phase floats on the top.

More and more water and oil in condensed form is then fed via the outlet channel 6 to the receiving vessel 7, so the liquid level there increases. On reaching the opening 81 of the overflow tube 8 into the receiving vessel 7 the liquid level increases further both in the receiving vessel 7 and in the overflow tube 8 (principle of communicating tubes). If the liquid level finally reaches the opening 82 of the overflow tube 8 into the connecting channel 4, firstly a thin layer of oil floating at the top and then water leaves the overflow tube 8 and enters the connecting channel 4.

More and more condensed water is then guided back through the overflow tube 8 via the connecting channel 4 to the receiving container 11 in the microwave chamber 1. At the same time, the level of the lighter oil phase in liquid form rises in the receiving vessel 7. This can be quantitatively detected by reading out by means of the level scale 71.

On completion of the method, the lower water phase can be discharged first and then the condensed oil, by means of the outlet valve 9.

Alternatively, a continuous outlet device for oil from the receiving vessel 7 through an outlet channel (not shown) can also be produced which leads out of the receiving vessel 7 approximately at the level of the scale 71.

As a further alternative, it is possible to extract the recovered oil from above with a pipette through an aperture which is, for example, arranged in the transition region of the outlet channel 6 to the receiving vessel 7.

FIG. 2 shows in a schematically simplified manner an alternative embodiment of the receiving container 11 in the microwave chamber 1. According to this variant, the receiving container 11′ is arranged obliquely, for example arranged inclined 45° to the vertical and rotatably mounted about an axis of rotation 16. A comparable device is known as such already from the German patent application 102 27 836.9 to which reference is expressly made with respect to the oblique position and the rotatable design of the receiving container.

As shown in FIG. 2, the receiving container 11′ according to this variant has a main part which is located in the microwave chamber 1 and a cylindrically formed extension tube 12 which is arranged symmetrically to the axis of rotation 16. The extension tube 12 projects outwardly through an aperture in the microwave chamber 1 and is rotatably mounted about the axis of rotation 16 at this point in a bearing 13.

The main part of the receiving container 11′ and the extension tube 12 may in this instance be designed, for example, in two parts to allow easy loading.

Furthermore, a holder 19 can be provided, for example designed in two parts, as shown schematically in FIG. 2, to hold the main part of the receiving container 11′ in the microwave chamber 1.

As also indicated in FIG. 2, a region 18 is formed in the main part of the receiving container 11′—asymmetrically to the axis of rotation 16—by a partition 22, to receive the biological material. On rotation about the axis 16, this separate region 18 therefore traverses on a circular path various positions within the microwave chamber 1. As a lack of homogeneity of the radiation field must be assumed in corresponding microwave chambers, this asymmetrical arrangement reduces the risk of a non-uniform irradiation of material.

An electric motor 14 is used for the drive, the force of which is transmitted via a driving pulley 17 to the extension tube 12 and therefore to the receiving vessel 11′. The entire driving device is located, in particular outside the microwave chamber 1 and is therefore easily accessible and also not exposed to any potential heating by microwave irradiation.

The extension tube 12 projects according to this variant beyond the driving device into a vapour receiving chamber 20. This has the form of a closed hood and covers the upper aperture of the extension tube 12. In its lower region, the vapour receiving chamber 20 is sealed against the extension tube 12 by means of a seal 21. If the requirements with respect to the degree of purity are correspondingly small, a seal between the steam receiving chamber 20 and the extension tube 12 may be dispensed with, however.

During the method, the vapour-containing air rises due to convection from the main part of the receiving container 11′ through the extension tube 12 and in this manner reaches the vapour receiving chamber 20.

At the top, the vapour receiving chamber 20 passes directly into the connecting channel 4 or, alternatively, is itself part of the connecting channel 4.

As an example of the efficiency of the method, it is stated that it is possible with the device according to the invention to obtain plant oils from one kilogram of rosemary with an energy supply of about 800 to 1000 watts over a time period of 20 minutes in a quantity for which with the conventional hydrodistillation method about 10 litres of water are required, which have to be heated for about 4 hours.

The advantages of the invention can be summarised as follows:

This is a solvent-free method which is particularly gentle and efficient.

The method can be carried out in a closed system so the introduction of undesired substances can be ruled out. The highest purity requirements can therefore be met, for example in conjunction with the production of homeopathic products.

The device consists of comparatively simple components and can therefore be classified as economical.

In comparison to conventional hydrodistillation methods, the method offers a considerable time saving.

What is claim is:

1. A Method of extracting a volatile natural substance from a biological material, wherein the biological material contains water, comprising the following steps:
a) introducing the biological material into a microwave chamber with the exclusion of solvent;
b) irradiating the biological material with microwaves until at least some of the natural substance is released from the biological material;
c) conveying the released natural substance from the microwave chamber into a condensation chamber by convection;
d) cooling the released natural substance until it condenses; and
e) conveying the released natural substance from the condensation chamber.

2. The method of claim 1, wherein the microwave chamber and the condensation chamber are parts of a closed system.

3. The method of claim 1, wherein the natural substance is a plant oil.

4. The method of claim 1, wherein in step b) the microwave irradiation is controlled in such a way that a temperature below 100° C. prevails in the microwave chamber.

5. The method of claim 1, wherein in step b) the biological material is stirred for improved exposure.

6. The method of claim 1, wherein the microwave chamber has an obliquely arranged, rotatable receiving container for improved exposure of the biological material.

7. The method of claim 1, wherein the condensation chamber is separated from the microwave chamber by a partition which has an upwardly tapering form and has an air-permeable aperture in the upper region.

8. The method of claim 7, wherein the partition is made from plastics material or glass.

9. The method of claim 1, wherein heat is fed into a transition region between the microwave chamber and the condensation chamber to assist convection.

10. The method of claim 1, wherein the condensation chamber is cooled in the wall region.

11. The method of claim 1, wherein the condensation chamber is cooled by water cooling.

12. The method of claim 1, wherein the condensation chamber has the form of a vertically oriented cylinder.

13. The method according to claim 1, wherein the condensed natural substance is discharged from the condensation chamber in step e) using gravitational force.

14. The method of claim 1, wherein in step e) water discharged with the natural substance is fed to the microwave chamber.

15. The method of claim 14, wherein the discharged water is at least partially separated from the natural substance by an overflow device and is fed to the microwave chamber.

16. The method of claim 1, wherein during irradiation the biological material is present in an atmosphere with reduced pressure.

17. A method of extracting a volatile natural substance from a biological material, wherein the biological material contains water, comprising the following steps:
a) introducing the biological material into a microwave chamber with exclusion of solvent;
b) irradiating the biological material with microwaves until at least some of the natural substance is released from the biological material, wherein during irradiation the biological material is present in an atmosphere with reduced pressure;
c) conveying the released natural substance from the microwave chamber into a condensation chamber;
d) cooling the released natural substance until it condenses; and
e) conveying the released natural substance from the condensation chamber.

18. A device for extracting a volatile natural substance from a biological material, comprising:
a. a microwave oven with a microwave chamber for receiving the biological material; and
b. a condensation chamber, wherein the condensation chamber is arranged above the microwave chamber, and is connected to the microwave chamber by a connecting channel.

19. The device of claim 18, wherein the microwave chamber and the condensation chamber form parts of a closed system.

20. The device of claim 18, wherein stirring means are provided for the microwave chamber for thorough mixing of introduced biological material.

21. The device of claim 20, wherein the microwave chamber has an obliquely arranged rotatable receiving container for biological material.

22. The device of claim 18, wherein the condensation chamber is separated from the microwave chamber by a partition which has an upwardly tapering form and has an air-permeable aperture in the upper region.

23. The device of claim 18, wherein the condensation chamber has the form of a vertically oriented cylinder.

24. The device of claim 18, wherein the connecting channel has the form of a vertically oriented cylinder.

25. The device of claim 18, wherein the connecting channel has a heating means.

26. The device according to claim 18, wherein the condensation chamber has a cooling means.

27. The device of claim 18, wherein the condensation chamber has water cooling.

28. The device of claim 18, wherein the condensation chamber in its base region has an outlet for conveying away condensed the natural substance.

29. The device of claim 28, wherein the outlet is connected to a receiving vessel for receiving condensed natural substance.

30. The device of claim 29, wherein the outlet is connected to an overflow device for separating the natural substance and water.

31. The device of claim 30, wherein the overflow device is connected to the connecting channel in such a way that overflowing water can flow into the microwave chamber owing to gravitational force.
